(19) United States
(12) Patent Application Publication
(10) Pub. No.: US 2011/0081135 A1
(43) Pub. Date: Apr. 7, 2011

(54) Far Infrared Panel for Humid and Dry Environments

(76) Inventor: Tracy Felder, Winsted, MN (US)

(21) Appl. No.: 12/573,882

(22) Filed: Oct. 6, 2009

(51) Int. Cl. H05B 1/00

(52) U.S. Cl. 392/407

(57) ABSTRACT

A far infrared panel for humid and dry environments includes a frame, a thin layer, a grounding circuit board, a cloth layer and a second layer. The thin layer includes a carbon membrane and a printed circuit board. Two wires are used to connect the carbon membrane with a control device. The grounding circuit board includes a grounding layer, a circuit board and a wire. The wire is used to connect the grounding circuit board with the ground. The second layer which has a crisscross pattern and a plurality of fixing devices are used to fixedly hold the thin layer, grounding circuit board and cloth layer in the frame. Therefore, the far infrared panel of the present invention may be used to raise the temperature of a sauna room swiftly and evenly and then can make users to sweat heavily.

### BACKGROUND OF THE INVENTION

1. Field of the Invention

The invention generally relates to a far infrared panel. More particularly, the invention relates to a far infrared panel that is a flat panel and emits far infrared radiation in humid and dry environments.

2. Description of the Prior Art

In the contemporary society, most people are busy with their job and career and are under a lot of stress. Most people have very little time for outdoor exercise. The lack of exercise results in the accumulation of fat and toxins and hence has adverse impacts on our physique and health. Therefore, various types of health enhancing devices have appeared to eliminate fat and toxins, increase the level of fitness and reduce stress.

Steam rooms or sauna rooms have become indispensable in big hotels, clubs and fitness centers. Sauna rooms use the hot steam to open up the pores and eliminate fat and toxins to reach the goal of swift perspiration. In addition, the high temperature of the stream can make users to sweat heavily after they leave the sauna room so as to improve the fatigue and the aching of the muscles and bones.

With regard to the traditional sauna rooms, fitness centers, foot heating buckets, floor heating devices of the prior art, one or several electrothermal layers are used to raise the temperature. However, the heat generated by the electrothermal layers can only reach objects that are very close to them and can not emit heat evenly. In addition, users sometimes get burned when they accidentally have contact with these layers and sometimes get electric shocks when the humidity level gets too high. Therefore, the electrothermal layer of the prior art needs to be improved.

### SUMMARY OF THE INVENTION

An object of the present invention is to provide a far infrared panel that can be used in a highly humid environment and in any sauna room so as to heat up the room swiftly and evenly.

Another object of the present invention is to provide a far infrared panel that uses carbon atoms to emit far infrared radiation. After carbon atoms absorb electric energy, they would first be raised to a stimulated state and, when they come down to their ground state, they would emit heat. According to the relevant studies, such heat comprises 68% of far infrared radiation and 32% of microwave radiation. The wavelength of such far infrared radiation is in the range from 2 to 18 micrometers and the wavelength of 70% of such far infrared radiation is in the range from 6 to 11 micrometers. Therefore, the choice of carbon atoms as the heating source can eliminate the disadvantages of the heating devices of the prior art and can benefit our health. In the far infrared panel of the present invention, special technology is employed to make carbon into a far infrared plate (i.e., the carbon membrane), which can withstand high temperatures, high levels of humidity, acidic environment and impacts. In addition, such carbon membrane is thin and large enough and can become a heat generating source when it is fed with electricity. Also, such heat source may be used to replace the heat source of a traditional sauna room.

A third object of the present invention is to provide a far infrared panel that has a grounding layer, which has a low electric resistance and has a crisscross pattern; therefore, it can absorb and block some of the electromagnetic radiation to reduce the adverse impacts on users.

A fourth object of the present invention is to provide a far infrared panel that has a grounding layer to protect users from electric shocks and eliminate static electricity.

To reach these objects, the far infrared panel of the present invention is disclosed. The far infrared panel of the present invention comprises a frame, a thin layer, a grounding circuit board, a cloth layer and a second layer. The thin layer includes a carbon membrane and a printed circuit board. Two wires are used to connect the carbon membrane with a control device. The grounding circuit board includes a grounding layer, a circuit board and a wire. The wire is used to connect the grounding circuit board with the ground. The grounding layer of the grounding circuit board may have a temperature regulating device, which can regulate the temperature of the far infrared panel. The second layer which has a crisscross pattern and a plurality of fixing devices are used to fixedly hold the thin layer, grounding circuit board and cloth layer in the frame.

These features and advantages of the present invention will be fully understood and appreciated from the following detailed description of the accompanying Drawings.

### BRIEF DESCRIPTION OF THE DRAWINGS

FIG. 1 is a perspective exploded view illustrating the far infrared panel of the present invention.

FIG. 2 is a block diagram illustrating how several far infrared panels (including the control device and relevant components) of the present invention are installed in an actual application.

FIG. 3 is a perspective view illustrating how several far infrared panels of the present invention (and relevant components) are used and installed in an indoor environment.

### DETAILED DESCRIPTION OF THE PREFERRED EMBODIMENTS

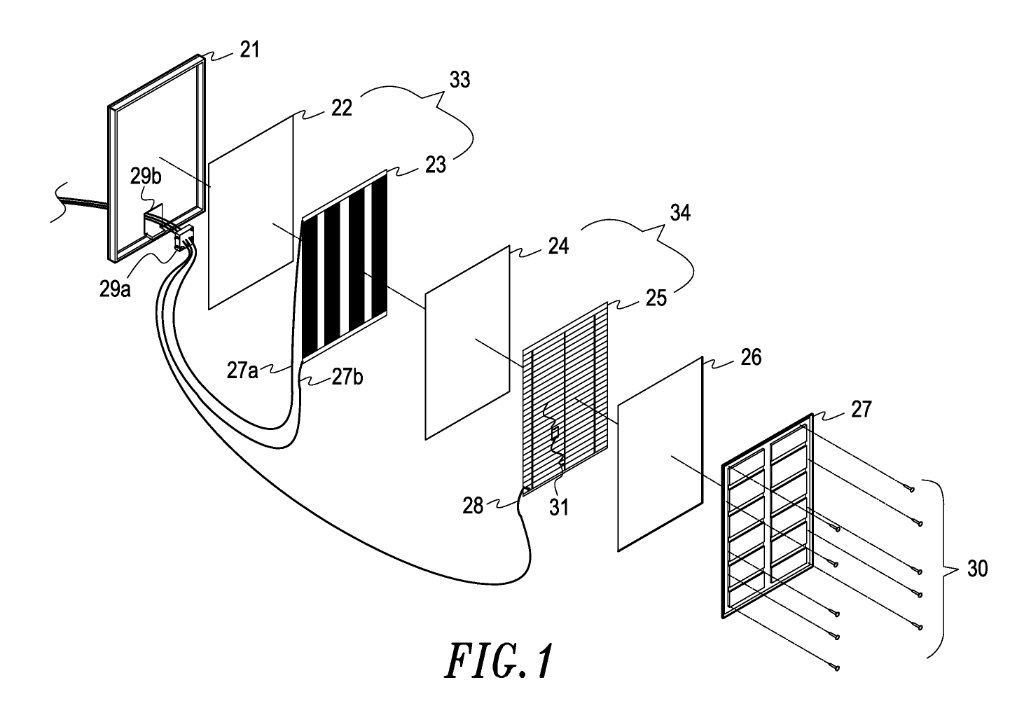

Please refer to FIG. 1, which is an exploded view illustrating the far infrared panel of the present invention. The far infrared panel of the present invention comprises a frame 21, a thin layer 33, a grounding circuit board 34, a cloth layer 26 and a second layer 27. The thin layer 33 is fitted onto the frame 21 and includes a carbon membrane 23 and a printed circuit board 22. Two wires 27a and 27b are used to connect the carbon membrane 23 with a control device 1. When the panel of the present invention is turned on, electricity would be fed to the carbon membrane 23 (27a and 27b are connected with the upper edge and lower edge of the carbon membrane 23, respectively). The collisions between electrons and the atoms fixed on the crystal lattices or impurities atoms can convert electricity to heat. When such heat is generated, the carbon membrane 23 would emit a lot of far infrared radiation. When such far infrared radiation reaches a user's body, his body would absorb it and convert it into heat; therefore, his body temperature would rise. Such far infrared radiation can go into the user's tissues deeply. It can cause the water molecules in the user's cells to resonate and speed up blood circulation. It can also help his metabolism and help the regeneration of the tissues. It can also bring up his immunity level and protect him from aging. To protect users from electric shocks and eliminate static electricity, a grounding circuit board 34 is used. The grounding circuit board 34 is fitted onto the thin layer 33 and includes a grounding layer 25, a circuit board 24 and a wire 28. The wire 28 is used to connect the grounding circuit board 34 with the ground. The grounding layer 25 has a low electric resistance and has a crisscross pattern; therefore, it can absorb and block some of the electromagnetic radiation. The grounding layer 25 of the grounding circuit board 34 has a temperature regulating device 31, which can regulate the temperature of the far infrared panel. A cloth layer 26 is used. The second layer 27 which has a crisscross pattern and a plurality of fixing devices 30 are used to fixedly hold the thin layer 33, grounding circuit board 34 and cloth layer 26 in the frame 21. The fixing devices 30 may be screws or bolts. A through hole 29b and a wire collecting box 29 may be disposed in the frame 21 to allow the passage and collection of the three wires 27a, 27b and 28.

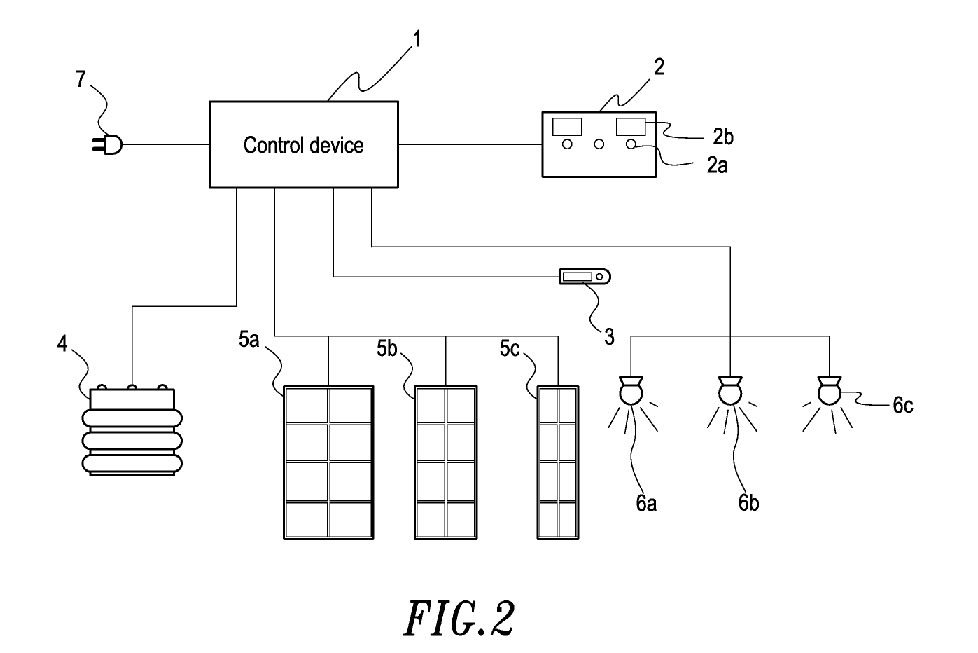

Now, please see FIG. 2, which is a block diagram illustrating how several far infrared panels (including the control device and relevant components) of the present invention are installed in an actual application. Each of the far infrared panels may be connected with a control device 1. A control panel 2 is connected with the control device 1, a plurality of adjustment devices 2a and display screens 2b to control the far infrared panels 5a, 5b and 5c. Each of the far infrared panels 5a, 5b and 5c may have a different shape and is connected the control device 1. A steam generator 4, a temperature sensor 3 and a plurality of lighting devices 6a, 6b and 6c may be used with the far infrared panels in an actual application.

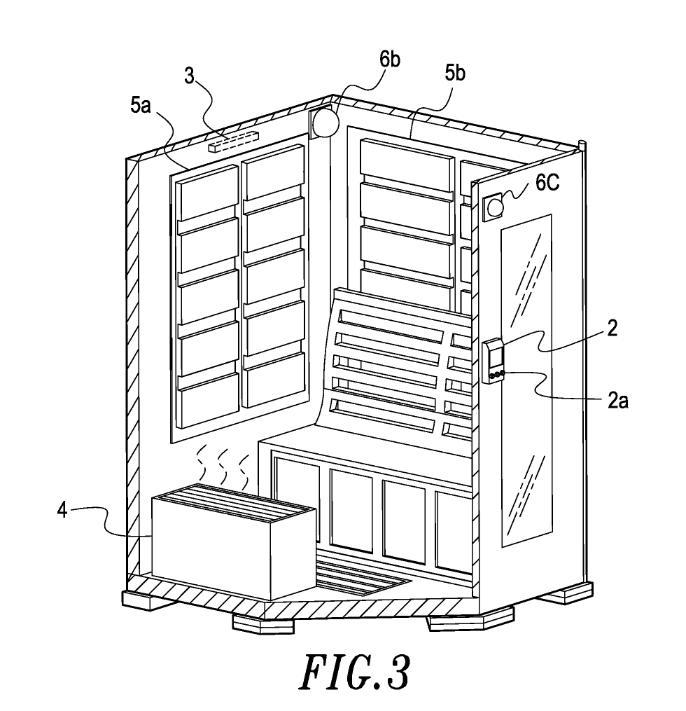

Please see FIGS. 2 and 3. FIG. 3 is a perspective view illustrating how several far infrared panels of the present invention (and relevant components) are used and installed in an indoor environment. The far infrared panels 5a and 5b may be installed on a wall or the floor of a sauna room. In this way, we can use the far infrared panels of the present invention with the steam generating device 4 of the prior art so that a user's whole body may receive far infrared radiation and get contact with the steam.

In comparison to the prior art, the far infrared panel of the present invention has the following advantages:
1. In the far infrared panel of the present invention, special technology is employed to make carbon into a far infrared plate (i.e., the carbon membrane), which can withstand high temperatures, high levels of humidity, acidic environment and impacts. In addition, such carbon membrane is thin and large enough and can become a heat generating source when it is fed with electricity. Also, such heat source may be used to replace the heat source of a traditional sauna room.
2. The grounding layer has a low electric resistance and may have a crisscross pattern; therefore, it can block some of the electromagnetic radiation (to reduce the harm to users).
3. The grounding layer can protect users from electric shocks and eliminate static electricity.

Although a preferred embodiment of the present invention has been described in detail hereinabove, it should be understood that the preferred embodiment is to be regarded in an illustrative manner rather than a restrictive manner, and all variations and modifications of the basic inventive concepts herein taught still fall within the scope of the present invention.

What is claimed is:

1. A far infrared panel for humid and dry environments, comprising:
a frame;
a thin layer, which is fitted onto the frame and includes a carbon membrane and a printed circuit board, and there are two wires used to connect the carbon membrane with a control device;
a grounding circuit board, which is fitted onto the thin layer and includes a grounding layer, a circuit board and a wire which is used to connect the grounding circuit board with ground;
a cloth layer, which is fitted onto the grounding circuit board; and
a second layer, having a plurality of fixing devices which is used to fixedly hold the thin layer, grounding circuit board and cloth layer in the frame.

2. The far infrared panel for humid and dry environments as in claim 1, wherein the grounding layer of the grounding circuit board has a crisscross pattern and absorbs and blocks electromagnetic radiation and then emits the electromagnetic radiation in form of heat.

3. The far infrared panel for humid and dry environments as in claim 1, wherein the grounding layer of the grounding circuit board has a temperature regulating device which regulates temperature of the far infrared panel.

4. The far infrared panel for humid and dry environments as in claim 1, wherein a through hole is disposed in the frame to allow a passage of the wires and a wire collecting box is used to collect the wires.

5. The far infrared panel for humid and dry environments as in claim 1, wherein the fixing devices of the second layer are screws or bolts.
